(19) United States
(12) Patent Application Publication
(10) Pub. No.: US 2015/0039345 A1
(43) Pub. Date: Feb. 5, 2015

(54) GENERATING VISUALIZATION IMAGES TO AID WITH MEDICATION ORGANIZATION BASED ON ELECTRONIC PRESCRIPTION RECORDS

(71) Applicant: International Business Machines Corporation, Armonk, NY (US)

(72) Inventors: Stephen J. MOORE, Austin, TX (US); Vanessa L. WILBURN, Austin, TX (US)

(21) Appl. No.: 14/485,716

(22) Filed: Sep. 13, 2014

Related U.S. Application Data
(63) Continuation of application No. 13/957,659, filed on Aug. 2, 2013.

(51) Int. Cl. G06F 19/00

(52) U.S. Cl. CPC G06F 19/3456; G06F 19/322
USPC 705/3

(57) ABSTRACT

In generating visualization images to aid with medication organization, a request for one or more medication organizer pages for a patient is received. The request includes a style of the patient's medication organizer. In response, the patient's electronic prescription records are retrieved from one or more prescription databases. Using the electronic prescription records, images for the medications in the prescription records are retrieved from a medication image database. Page layouts for the medication organizer pages are selected based on the style of the patient's medication organizer. The images and prescription information from the electronic prescription records are assembled into the page layout for the medication organizer pages. The medication organizer pages may be returned for displaying or printing.

### BACKGROUND

“Adherence” or “compliance” refers to how dutifully a patient follows medical recommendations, especially recommendations for the timing and dosage of prescription medications. Poor adherence is a major health and economic problem and can have harmful results which may lead to hospital costs and even death. Many patients, especially seniors, take multiple prescription medications, each with its own schedule and dosage. These patients can struggle to interpret the instructions on their prescriptions into correct arrangements of medications in their medication organizers. Failure to properly interpret the instructions may result in omitting or over-consuming medications. Adding to the possibility of poor adherence, many prescriptions are filled with generic medications, with the specific brand and the look of the medication varying from one prescription refill to another.

### SUMMARY

According to one embodiment of the present invention, in generating visualization images to aid with medication organization, a request for one or more medication organizer pages for a patient is received. The request includes a style of the patient's medication organizer. In response, the patient's electronic prescription records are retrieved from one or more prescription databases. Using the electronic prescription records, images for the medications in the prescription records are retrieved from a medication image database. Page layouts for the medication organizer pages are selected based on the style of the patient's medication organizer. The images and prescription information from the electronic prescription records are assembled into the page layout for the medication organizer pages. The medication organizer pages may be returned for displaying or printing.

System and computer program products corresponding to the above-summarized methods are also described and claimed herein.

### BRIEF DESCRIPTION OF THE SEVERAL VIEWS OF THE DRAWINGS

FIG. 1 illustrates an embodiment of a system for generating visualization images to aid with medication organization according to the present invention.

FIG. 2 illustrates an embodiment of a computer system in the system for generating visualization images to aid with medication organization according to the present invention.

FIG. 3 illustrates an embodiment of a method for generating visualization images to aid with medication organization according to the present invention.

FIGS. 4A-4C illustrate example medication organizer pages created in accordance with an embodiment of the present invention.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java® (Java, and all Java-based trademarks and logos are trademarks of Sun Microsystems, Inc. in the United States, other countries, or both), Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer special purpose computer or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified local function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

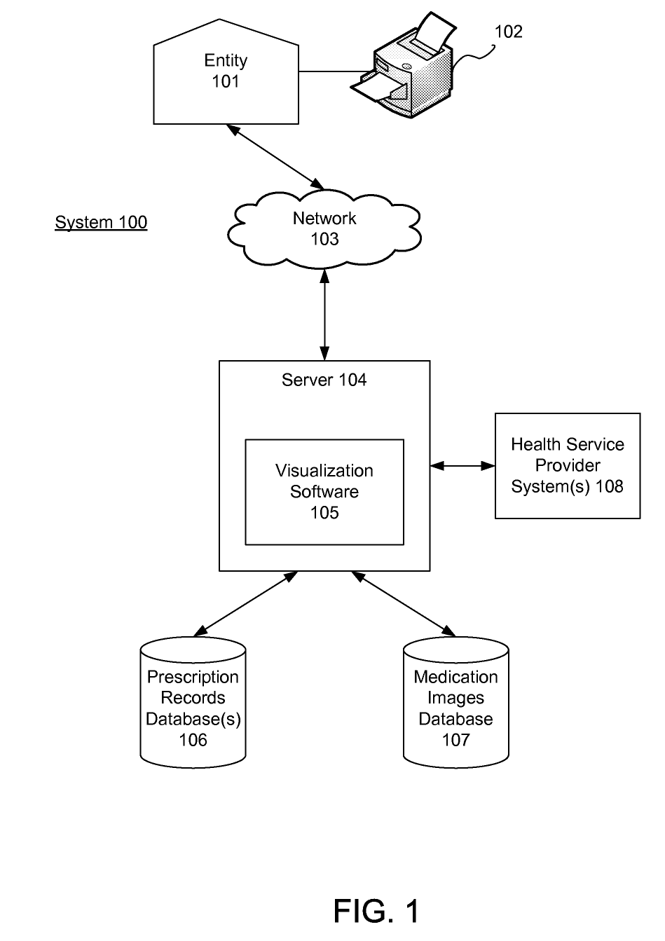

FIG. 1 illustrates an embodiment of a system for generating visualization images to aid with medication organization according to the present invention. In this embodiment, the system 100 includes an entity which requests a medication organizer page for a patient, such as an entity 101, such as a pharmacy. The entity 101 communicates with a server 104 over a network 103, such as the Internet. The server 104 includes visualization software 105 for creating the medication organizer page for the patient, using information retrieved from one or more electronic prescription records databases 106 and a medication images database 107, and optionally from one or more health service provider systems 108. The server 104 returns the medication organizer page for the patient to the entity 101, where the page may be printed using a printer 102. The printed medication organizer page may then be used by the patient to organize medications in his or her medication organizer.

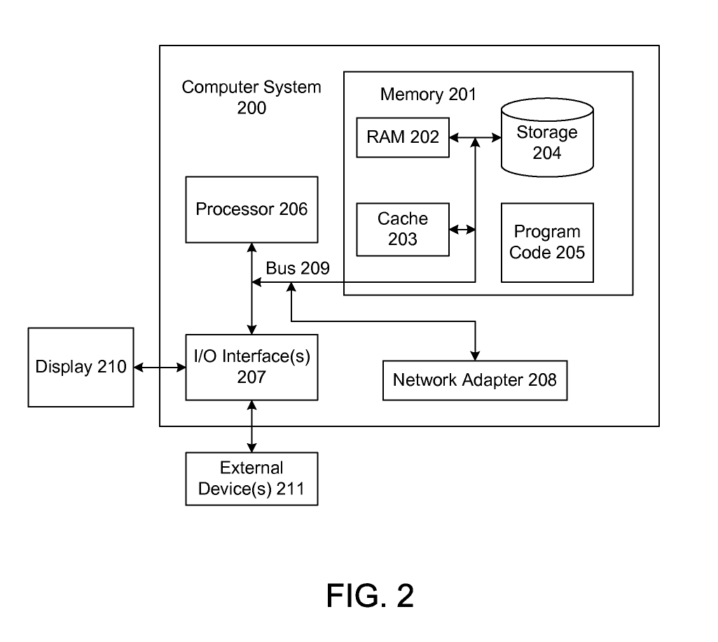

FIG. 2 illustrates an embodiment of a computer system in the system for generating visualization images to aid with medication organization according to the present invention. The computer system 200 may be the server 104 illustrated in FIG. 1 and any other computer system in the system 100. The computer system 200 is operationally coupled to a processor or processing units 206, a memory 201, and a bus 209 that couples various system components, including the memory 201 to the processor 206. The bus 209 represents one or more of any of several types of bus structure, including a memory bus or memory controller, a peripheral bus, an accelerated graphics port, and a processor or local bus using any of a variety of bus architectures. The memory 201 may include computer readable media in the form of volatile memory, such as random access memory (RAM) 202 or cache memory 203, or non-volatile storage media 204. The memory 201 may include at least one program product having a set of at least one program code module 205 that are configured to carry out the functions of embodiment of the present invention when executed by the processor 206. The computer system 200 may also communicate with one or more external devices 211, such as a display 210, via I/O interfaces 207. The computer system 200 may communicate with one or more networks via network adapter 208.

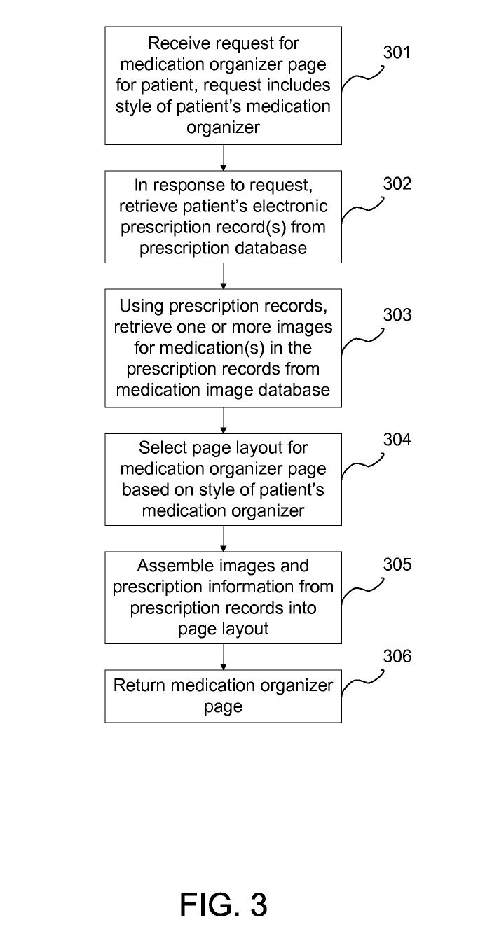

FIG. 3 illustrates an embodiment of a method for generating visualization images to aid with medication organization according to the present invention. In this embodiment, the method is implemented by executing the visualization software 105 at the server 104. First, the server 104 receives a request for a medication organizer page for a patient (301). The request includes an indication of the style of the patient's medication organizer. For example, assuming the entity 101 is a pharmacy, the style of the medication organizer may be obtained from the patient when the patient visits the pharmacy. The patient may have a commercially available medication organizer, for which the pharmacy or the server 104 has a description, or provide the pharmacy with a description of a non-commercially available medication organizer. The pharmacy includes the style of the medication organizer, as well as patient identifying information, in the request to the server 104 for the medication organizer page.

In response to receiving the request, the server 104 retrieves the patient's electronic prescription record(s) from the prescription database(s) 106 (302). An electronic prescription record includes information for each medication prescribed to the patient, such as name of the medication, schedule, dosage, and any other instructions related to the medication. Using the prescription records, the server 104 retrieves one or more images for the medications in the prescription records from the medication image database 107 (303). Depending on the level of completeness of the medication image database 107, images for all or less than all of the medications in the prescription records are retrieved. Optionally, when an image for a particular medication is not available, a default image may be used, in conjunction with or without text. The server 104 further selects a page layout for the medication organizer page based on the style of the patient's medication organizer (304). For non-commercially available medication organizers, the server 104 creates a custom page layout based on the description of the medication organizer provided in the request. When the medication organizer includes a set of containers with varying configurations, multiple pay layouts may be selected. The server 104 assembles the images retrieved from the medication image database 107 and the prescription information from the patient's prescription records into the page layout (305). When the prescription information includes “sig codes”, i.e., abbreviations used in medical prescriptions, the server 104 translates these codes into visual indicators or text of common terms. When the prescription records indicate that dosage instructions vary over time, multiple pages may be assembled by the server 104 to reflect the variations. For example, if the patient's medication organizer is of the weekly style, and the instructions vary over four weeks, four medication organizer pages, one for each week, may be assembled by the server 104. Optionally, any over-the-counter medications taken by the patient may also be included in the medication organizer page. For example, a record for the over-the-counter medication for the patient may be added to the prescription records database 106. Further, when a medication is related to an upcoming appointment or procedure, any instructions related to the appointment or procedure may also be retrieved from the health service provider systems 108 and be included in the medication organizer page.

The server 104 then returns the medication organizer page, which may be displayed or printed (306). For example, the server 104 may return the medication organizer page to the pharmacy in a Portable Document Format (PDF). The pharmacy then prints the medication organizer page, preferably in color, and gives it to the patient. The patient may then use his or her medication organizer page when filling the medication organizer with his or her medications. In this manner, the patient is provided a visual guide, containing multiple prescriptions on the same medication organizer page, which assists in reducing the misreading or misinterpretation of the dosage instructions.

Although the example described above is described in the context of a pharmacy, the medication organizer page may also be provided to the patient through other channels. For example, the medication organizer page may be delivered electronically or by mail, such as when the patient refills prescriptions by mail, online, or by phone.

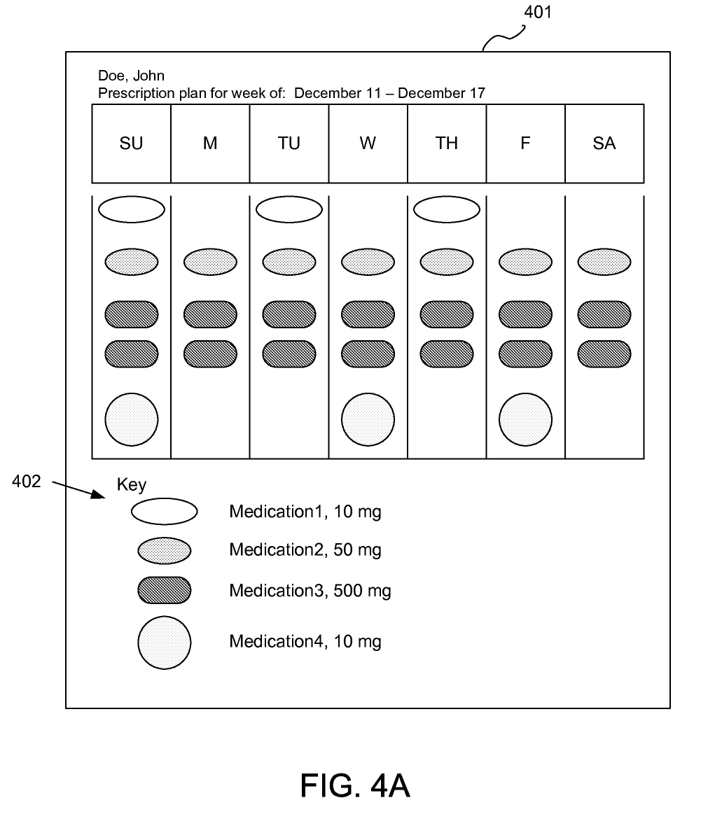

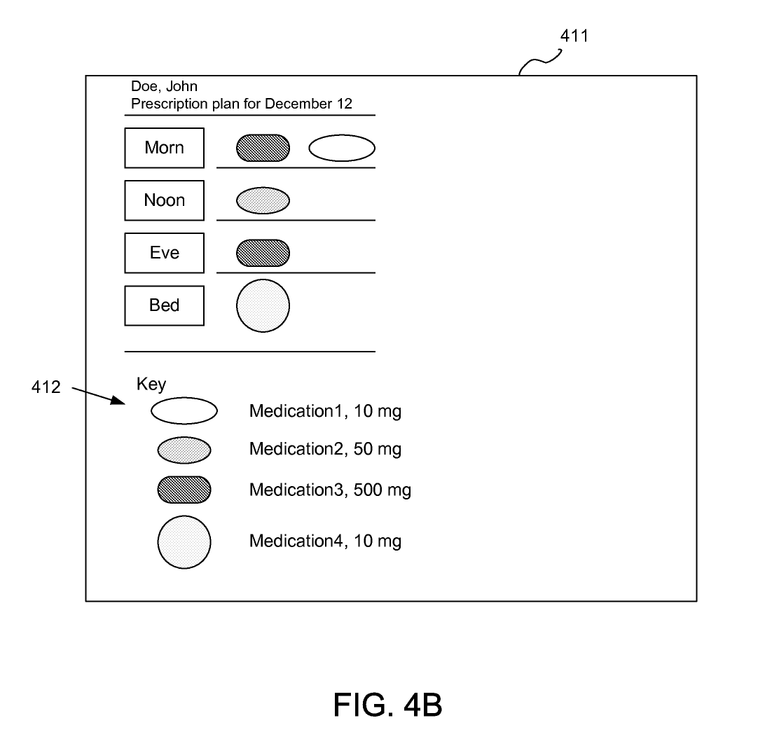

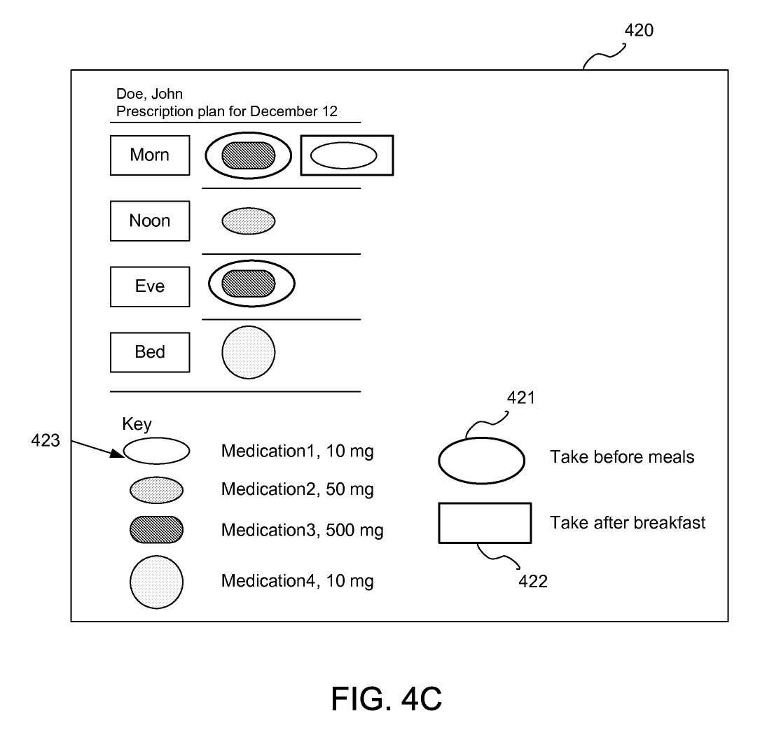

FIGS. 4A-4C illustrate example medication organizer pages created in accordance with an embodiment of the present invention. FIG. 4A illustrates an example medication organizer page created for a weekly style medication organizer which has one box for each day of the week. The medication organizer page 401 visually indicates the days of the week in a manner that matches the organizer. The page may show actual-sized color representations of the medications. Under each day indicated, an image of each medication the patient is to take is displayed. A key 402 for each image may be provided. In this example, Medication1 is to be taken on Sunday, Tuesday, and Thursday. The image of Medication1 is thus displayed only for those days. One of Medication 2 is to be taken each day, thus the image of Medication2 is displayed once for each day. Two of Medication3 is to be taken each day. Thus, the image of Medication3 is displayed twice under each day. Medication4 is to be taken on Sunday, Wednesday, and Friday. The image of Medication4 is thus displayed only for those days.

FIG. 4B illustrates an example medication organizer page for a daily style medication organizer with a box for the morning, noon, evening, and bedtime. The medication organizer page 411 visually indicates the times of day in a manner that matches the organizer. Under each time of day, an image of each medication the patient is to take is displayed. A key 412 for each image may be provided. In this example, Medication1 is to be taken only in the morning, thus the image of Medication1 is displayed only for “Morn”. Medication 2 is to be taken at noon, thus the image of Medication2 is displayed only for “Noon”. Medication3 is to be taken both in the morning and in the evening. Thus, the image of Medication3 is displayed for “Morn” and “Eve”. Medication4 is to be taken only before at bedtime, thus, the image of Medication4 is displayed only for “Bed”. In this example, the patient may be given such a page for each day of the week.

FIG. 4C illustrates another example medication organizer page for a daily style medication organizer with a box for the morning, noon, evening, and bedtime. In this example, in addition to the visual guide provided in the page 411 illustrated in FIG. 4B, the medication organizer page 420 provides visual indications for further dosage instructions. In this example, Medication3 is to be taken before meals, thus, the visual indication 421 is added to the images of Medication3. Medication1 is to be taken after breakfast, thus, the visual indication 422 is added to the image of Medication1. The meaning of the visual indications 421 and 422 are provided as part of the key 423. The dosage instructions represented by the visual indications 421 and 422 may have been translated from sig codes in the patient's prescriptions, as described above.

The descriptions of the various embodiments of the present invention has been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for generating visualization images to aid with medication organization, implemented by a computing processor, comprising:
receiving by the computing processor a request for one or more medication organizer pages for a patient, the request comprising a style of the patient's medication organizer;
in response to receiving the request, retrieving by the computing processor one or more of the patient's electronic prescription records from one or more prescription databases;
using the electronic prescription records, retrieving by the computing processor one or more images for one or more medications in the one or more prescription records from a medication image database;
selecting by the computing processor one or more page layouts for the one or more medication organizer pages based on the style of the patient's medication organizer; and
assembling by the computing processor the one or more images and prescription information from the one or more electronic prescription records into the one or more page layouts for the one or more medication organizer pages.

2. The method of claim 1, wherein the assembling of the one or more images and the prescription information from the one or more electronic prescription records into the page layout for the one or more medication organizer pages, comprises:
assembling the one or more images and the prescription information for use in displaying or printing to comprise schedule and dosage information for the one or more medications.

3. The method of claim 1, wherein one or more of the electronic prescription records comprise sig codes, wherein the assembling of the one or more images and the prescription information from the one or more electronic prescription records into the one or more page layouts for the one or more medication organizer pages further comprises:
translating the sig codes into visual indicators or text of common terms; and
including the visual indicators or the text of common terms in the one or more page layouts.

4. The method of claim 1, wherein the assembling of the one or more images and the prescription information from the one or more electronic prescription records into the one or more page layouts for the one or more medication organizer pages further comprises:
including any over-the-counter medications taken by the patient in the one or more page layouts.

5. The method of claim 1, wherein one or more of the electronic prescription records relate to an appointment or procedure for the patient, wherein the assembling of the one or more images and the prescription information from the one or more electronic prescription records into the one or more page layouts for the one or more medication organizer pages further comprises:
retrieving from a health service provider system instructions related to the appointment or the procedure for the patient; and
including the instructions related to the appointment or the procedure for the patient in the one or more page layouts.

6. The method of claim 1, wherein the prescription information from the one or more electronic prescription records vary over a time period, wherein the assembling of the one or more images and the prescription information from the one or more electronic prescription records into the one or more page layouts for the one or more medication organizer pages comprises:
assembling a medication organizer page for each variation over the time period.

7. The method of claim 1, wherein the assembling of the one or more images and the prescription information from the one or more electronic prescription records into the one or more page layouts for the one or more medication organizer pages further comprises:
including a key for the one or more images in the one or more page layouts.
